(19) United States
(12) Patent Application Publication
(10) Pub. No.: US 2009/0286059 A1
(43) Pub. Date: Nov. 19, 2009

(54) FIBER SHEET

(75) Inventors: Masanori Ogawa, Aichi (JP); Watanabe Tsuyoshi, Aichi (JP); Fujii Makoto, Aichi (JP)

Correspondence Address: COOPER & DUNHAM, LLP, 30 Rockefeller Plaza, 20th Floor, NEW YORK, NY, 10112, US

(73) Assignee: NAGOYA OIL CHEMICAL CO., LTD., Tokai-shi (JP)

(21) Appl. No.: 12/306,468

(22) PCT Filed: Jun. 18, 2007
(86) PCT No.: PCT/JP2007/062234

§ 371 Date: Dec. 23, 2008

(30) Foreign Application Priority Data
Jul. 3, 2006 (JP) 20061822999

(51) Int. Cl. B32B 5/26; B32B 5/02

(52) U.S. Cl. 428/219; 442/381

(57) ABSTRACT

The present invention provides a fiber sheet comprising a mixture of rigid vegetable fiber and other fiber, and the fiber sheet is easily manufactured, and has an excellent rigidity and sound absorbing property.

### FIELD OF THE INVENTION

The present invention relates to a fiber sheet, a laminated fiber sheet, a molded fiber sheet or a molded laminated fiber sheet, which is used, for example, for the interior or exterior base material of a car.

### BACKGROUND OF THE INVENTION

Hitherto, glass fiber is often used to impart rigidity to such as the interior or exterior base material of a car, and the like.

Nevertheless, said glass fiber has a fault in that it fractures into minute fibers during handling, such as transportation, molding, and the like, said minute fibers scattering to deteriorate the working surroundings.

In a case where a synthetic resin fiber such as polyester fiber or the like is used, it may be necessary to increase the amount of synthetic resin binder added to obtain a fiber sheet having desirable rigidity (JP H6-16096).

Nevertheless, there is a problem in that in a case where the amount of synthetic resin binder added is increased, the weight is also increased, and its rigid resinous property becomes dominant over its fibrous property.

Therefore, it has been recently thought to substitute glass fiber for rigid vegetable fiber such as kenaf fiber, hemp fiber, coconut fiber, bamboo fiber or the like.

For example, JP2004-314593 discloses a method for manufacturing a fiber board by hot pressing a mat of rigid vegetable fiber (kenaf fiber) into which a thermosetting resin has been impregnated, and JP2001-179716 discloses a fiber board which is manufactured by heating a mat of a fiber mixture consisting of a mix of a rigid vegetable fiber (kenaf fiber, jute fiber) and a substantially equal amount of polypropylene fiber, to soften said polypropylene fiber, then cold pressing said heated mat.
Patent Literature 1: JP H6-16096
Patent Literature 2: JP2004-314593
Patent Literature 3: JP2001-179716

### DISCLOSURE OF THE INVENTION

The rigid vegetable fiber has problems in that since it is rigid and said fibers are so hard to intertwine, sheet forming is difficult, and pressing with a high pressure is necessary for sheeting but pressing with a high pressure interferes with the penetration of synthetic resin binder and powdery flame retardant into said sheet.

In a mat consisting of a mixture in which said rigid vegetable fiber and polypropylene fiber are mixed in an almost equal amount, said fibers easily intertwine by mixing in soft polypropylene fiber, so that sheeting without high pressure pressing can be applied.

Nevertheless, since polypropylene fiber is mixed in with said rigid vegetable fiber in almost equal amount in said mat, when said mat is hot-pressed to mold, the melted polypropylene fiber causes sticking to the mold, the melted article's releasability being damaged, and deformation may occur, deteriorating its surface smoothness.

Accordingly, to solve said problems, said mat should first be heated to soften said polypropylene fiber, and then said mat should be cold-pressed to mold, but said method needs two processes, the heating process and molding process, resulting in a deterioration of productivity.

### Means to Solve Said Problems

To solve said problems, the present invention provides a fiber sheet consisting of a fiber mixture including 55 to 95% by mass of rigid vegetable fiber and 5 to 45% by mass of other fiber.

It is preferable that the apparent density of said fiber sheet is in the range of between 4 to 50 kg/m³, and further that said rigid vegetable fiber and/or said other fiber having a fineness of 10 dtex or above is(are) contained in said fiber sheet in an amount of 20% by mass or above, and that the whole of or a part of said other fiber has low melting point of 180° C. or below. In this case said fiber having a low melting point is preferably a core-shell type composite fiber, the shell part of which is made of a thermoplastic synthetic resin having a low melting point of between 100 and 180° C.

Generally, it is preferable the fibers of said fiber sheet are intertwined by needle punching, and/or bound by a synthetic resin binder, and/or a melted fiber having a low melting point.

Further, a synthetic resin is preferably impregnated into a fiber sheet, and said synthetic resin is preferably a phenolic resin. Said phenoloc resin is preferably sulfomethylated and/or sulfimethylated.

In a case where said fiber sheet is used as a base of the interior of a car and the like, a powdery solid flame retardant is preferably mixed therein, and in this case, said powdery solid flame retardant is preferably polyammonium phosphate having an average degree of polymerization in the range of between 10 to 40, its particle diameter being 200 μm or below.

If desirable, (a) non-woven fabric(s) may be laminated onto one side or both sides of said fiber sheet.

The present invention also provides a molded fiber sheet, wherein a fiber sheet or a laminated fiber sheet is molded into a desired shape.

### EFFECT OF THE INVENTION

### [Action]

### The Invention of Claim 1

A mixture of 55 to 95% by mass of a rigid vegetable fiber and 5 to 45% by mass of other fiber is easily molded into a sheet since said other fiber has the flexibility to promote intertwining in said mixture.

### The Invention of Claim 2

In a case where the apparent density of said fiber sheet is in the range of between 4 and 50 kg/m³, the sound absorbing property of said fiber sheet improves, and further an excellent rigidity is imparted to said fiber sheet, and still further the synthetic resin and powdery solid flame retardant easily penetrate into said fiber sheet from its surface.

### The Invention of Claim 3

In a case where said rigid vegetable fiber and/or said other fiber having a fineness of 10 dtex or above, is(are) contained in said fiber mixture in an amount of 20% by mass or above, the structure of the resulting fiber sheet becomes thin, making said fiber sheet become lighter, the synthetic resin and powdery solid flame retardant easily penetrate into said fiber sheet. Further, when said fiber sheet into which said synthetic resin has been impregnated is roll squeezed, said thick fibers contribute to the progress of restoring the thickness of said fiber sheet after being squeezed.

### The Invention of Claim 4

In a case where a fiber sheet wherein the whole of or a part of said other fiber is a fiber having a low melting point of 180° C. or below, the resulting fiber sheet is easily molded by hot-pressing and since said fiber, having a low melting point, is contained in said fiber sheet in an amount of 45% by mass or below, the resulting molded sheet by hot-pressing can be easily released from the mold face without crumbling its molded shape, so that a molded fiber sheet with a smooth surface is obtained.

### The Invention of Claim 5

In a case where said fiber having a low melting point is a core-shell type composite fiber, the shell part of which is made of a thermoplastic synthetic resin having a low melting point of between 100 and 180° C., since the core part of said core-shell type composite fiber has excellent rigidity and heat resistance, the deterioration of the rigidity and the heat resistance of the resulting fiber sheet caused by the fiber having a low melting point in said fiber sheet is avoided.

### The Invention of Claim 6

In a case where the fibers of said fiber sheet are intertwined by needle punching, and/or bound by a synthetic resin binder, and/or a melted fiber having a low melting point, the resulting fiber sheet has a good form stability without molded shape crumbling.

### The Invention of Claim 7

In a case where a synthetic resin has been impregnated into said fiber sheet, the rigidity of the fiber sheet is improved and said fiber sheet gains both good moldability and molded form stability.

### The Invention of Claim 8

In a case where said synthetic resin is a phenolic resin, the form stability and the dimensional stability of the resulting molded fiber sheet is improved, and further, since said phenolic resin is preservative, said phenolic resin prevents the decay of said rigid vegetable fiber in said fiber sheet.

### The Invention of Claim 9

In a case where said phenolic resin is sulfomethylated and/or sulfimethylated, the water solution of said phenolic resin is stable in the wide range of pH, so that even if a curing agent or other additive(s) is(are) added to said water solution, said water solution remains stable.

### The Invention of Claim 10

In a case where a powdery solid flame retardant is mixed into said fiber sheet, a suitable flame retardancy is imparted to said fiber sheet, being useful for the interior or exterior base material of a car or the like. As described above, in a case where said rigid vegetable fiber and/or said other fiber having a fineness of 10 dtex or above is(are) contained in said fiber sheet in an amount of 20% by mass or above, said powdery solid fire retardant can penetrate into the inside of said fiber sheet, so that said fiber sheet gains an excellent flame retardancy.

### The Invention of Claim 11

In a case where said powdery solid flame retardant is polyammonium phosphate having an average degree of polymerization in the range of between 10 to 40 with a particle diameter of 200 μm or below, said powdery solid flame retardant can smoothly penetrate into the inside of said sheet. Further, since polyammonium phosphate having an average degree of polymerization in the range of between 10 and 40 is difficult to dissolve or is insoluble in water, said polyammonium phosphate can be penetrated into said fiber sheet as a dispersion prepared by dispersing said polyammonium phosphate in water, to impart the flame retardancy having a good water resistance and weatherability to said fiber sheet.

### The Invention of Claim 12

In a case where (a) nonwoven fabric(s) is(are) laminated onto one side or both sides of: said fiber sheet, said nonwoven fabric(s) cover(s) one side or both sides of said fiber sheet into which the synthetic resin has been impregnated, said fiber sheet containing said rigid vegetable fiber, imparting (a) minute smooth surface(s) to said fiber sheet as well as improving said fiber sheet's sound absorbing property.

### The Invention of Claim 13

Said molded fiber sheet prepared by molding said fiber sheet or said laminated fiber sheet into a prescribed shape has excellent rigidity, form stability and sound absorbing property, and moreover, a high flame retardancy can be imparted to said molded fiber sheet.

### [Effect]

The present invention provides a light fiber sheet, and a light molded fiber sheet having excellent rigidity, form stability and sound absorbing property.

### PREFERRED EMBODIMENT TO PRACTICE THE INVENTION

The present invention is described below.

### [Rigid Vegetable Fiber]

The vegetable rigid fiber used in the present invention is such as kenaf fiber, hemp fiber, bamboo fiber, abaca fiber or the like, and it is desirable to select kenaf fiber which is easily fiberized, available at a cheap price, and provides an easily moldable sheet.

The fineness of said rigid vegetable fiber is preferably in the range of between 10 and 60 dtex.

### [Other Fiber]

In the present invention, a fiber mixture consisting of 55 to 95% by mass of said rigid vegetable fiber and 5 to 45% by mass of other fiber is used. In a case where the amount of said rigid vegetable fiber is beyond 95% by mass, the intertwining of said fibers is to be unexpected, making sheet forming difficult, while in the case where the amount of said rigid vegetable fiber is below 55% by mass, the rigidity of the resulting fiber sheet is not enough to deteriorate the molded form's stability.

Said other fiber to be mixed in said rigid vegetable fiber is a flexible fiber which is easily intertwined, for example, synthetic fiber such as polyester fiber, polyamide fiber, acrylic fiber, urethane fiber, polyvinyl chloride fiber, polyvinylidene chloride fiber, acetate fiber, or the like, natural fiber such as wool, mohair, cashmere, camel hair, alpaca, vicuna, angora, silk, or the like, biodegradable fiber made from lactic acid produced from such as corn starch, or the like, cellulose group synthetic fiber such as rayon fiber, staple fiber, polynosic fiber, cupro-ammonium rayon fiber, acetate fiber, triacetate fiber, or the like, inorganic fiber such as glass fiber, carbon fiber, ceramic fiber, asbestos fiber, or the like, and reclaimed fiber obtained by the fiberizing of a fiber product made of said fibers. Said fiber is used singly, or two or more kinds of said fiber may be used in combination in the present invention. The fineness of said fiber is preferably in the range of between 0.1 dtex and 60 dtex.

Further, in this invention, fiber having a low melting point of 180° C. or below is desirably used wholly or partially as said other fiber.

Said low melting point fibers include, for example, polyolefine group fiber such as polyethylene fiber, polypropylene fiber ethylene-vinyl acetate copolymer fiber, ethylene-ethyl acrylate copolymer fiber, or the like, polyvinyl chloride fiber, polyurethane fiber, polyester fiber, polyester copolymer fiber, polyamide fiber, polyamide copolymer fiber, or the like. Said fibers having a low melting point may be used singly, or two or more kinds of said fiber may be used in combination.

The fineness of said low melting point fiber is preferably in the range of between 0.1 and 60 dtex.

In the present invention, a desirable fiber having a low melting point is, for example, core-shell type composite fiber which uses the ordinary fiber described above as a core part, and uses a thermoplastic resin having a low melting point of 100 to 180° C., being the resin material of said low melting point fiber, as a shell.

In a case where said core-shell type composite fiber is used, the rigidity, the heat resistance of the resulting fiber sheet does not deteriorate.

In said fiber mixture, thick fibers having a fineness of more than 10 dtex are desirably included in an amount of more than 20% by mass. Said thick fiber may only be said rigid vegetable fiber or only other fiber or both said rigid vegetable fiber and said other fiber.

In a case where said thick fiber is contained in said fiber mixture beyond 20% by mass, the structure of the resulting fiber sheet becomes thin, making resulting fiber sheet light, and the synthetic resin binder and powdery solid flame retardant easily penetratable to the inside of said fiber sheet. Further, in a case where the synthetic resin is impregnated into said fiber sheet, following which said fiber sheet is roll squeezed, said thick fiber in said fiber sheet aids the recovery of the thickness of said fiber sheet after being roll squeezed. In particular, in a case where a polyester fiber is used as said other fiber, since said polyester fiber itself has bounce impact elasticity, said polyester fiber significantly aids the recovery of the thickness of said fiber sheet after being roll squeezed.

### (Preparing the Fiber Sheet)

Said fiber sheet of the present invention is prepared by a process wherein the web sheet or mat of said fiber mixture is needle-punched, or a process wherein in a case where said web sheet or mat consists of or includes a fiber having a low melting point, said sheet or mat is heated to soften said fiber having a low melting point so as to be a binder, or a synthetic resin is impregnated or mixed into said sheet or mat as a binder, or first said sheet or mat is needle punched and, then heated to soften to be a binder, or a process wherein said synthetic resin binder is impregnated into said sheet or mat to bind the fibers in said sheet or mat, or a process wherein said fiber mixture is knitted or woven.

As said synthetic resin binder, a synthetic resin solution or emulsion the same as the synthetic resin to be impregnated into said fiber sheet of the present invention described below is used.

(The Fiber Sheet into which a Synthetic Resin is Impregnated)

A synthetic resin is be impregnated into said fiber sheet to impart rigidity and good moldability.

### (Synthetic Resin)

Said synthetic resin to be impregnated into said fiber sheet is, for example, a thermoplastic synthetic resin such as polyethylene, polypropylene, ethylene-propylene copolymer, ethylene-propylene terpolymer, ethylene-vinyl acetate copolymer, polyvinyl chloride, polyvinylidene chloride, polystyrene, polyvinyl acetate, fluorocarbon polymers, thermoplastic acrylic resin, thermoplastic polyester, thermoplastic polyamide, thermoplastic urethane resin, acrylonitrile-butadiene copolymer, styrene-butadiene copolymer, acrylonitrile-butadiene-styrene copolymer, or the like; a thermosetting resin such as urethane resin, melamine resin, heat hardening type acrylic acid resin, urea resin, phenolic resin, epoxy resin, heat hardening type polyester, or the like, and further, a synthetic resin precursor which produces said synthetic resin such as prepolymer, oligomer monomer, or the like may be used. Said prepolymer, ologomer or monomer may include a urethane resin prepolymer, epoxy resin prepolymer, melamine resin prepolymer, urea resin prepolymer, phenol resin prepolymer, diallyl phthalate prepolymer, acrylic oligomer, polyisocyanate, methacryl ester monomer, diallyl phthalate monomer, or the like. Said synthetic resin binder may be used singly, or two or more kinds of said synthetic resin may be used together, and said synthetic resin binder may be commonly provided as a powder, emulsion, latex, water solution, organic solvent solution, or the like.

A desirable synthetic resin binder to be used in this invention is a phenol group resin. Said phenol group resin to be used in this invention is described below.

Said phenol group resin is produced by the condensation reaction between the phenol group compound and formaldehyde and/or a formaldehyde donor.

### (Phenol Group Compound)

The phenolic compound used to produce said phenolic resin may be a monohydric phenol, or polyhydric phenol, or a mixture of monohydric phenol and polyhydric phenol, but in a case where only a monohydric phenol is used, formaldehyde is apt to be emitted when or after said resin composition is cured, making polyphenol or a mixture of monophenol and polyphenol most desirable.

### (Monohydric Phenol)

The monohydric phenols include an alkyl phenol such as o-cresol, m-cresol, p-cresol, ethylphenol, isopropylphenol, xylenol, 3,5-xylenol, butylphenol, t-butylphenol, nonylphenol or the like; a monohydric derivative such as o-fluorophenol, m-fluorophenol, p-fluorophenol, o-chlorophenol, m-chlorophenol, p-chlorophenol, o-bromophenol, m-bromophenol, p-bromophenol, o-iodophenol, m-iodophenol, p-iodophenol, o-aminophenol, m-aminophenol, p-aminophenol, o-nitrophenol, m-nitrophenol, p-nitrophenol, 2,4-dinitrophenol, 2,4,6-trinitrophenol or the like; a monohydric phenol of a polycyclic aromatic compound such as naphthol or the like. Each monohydric phenol can be used singly, or as a mixture thereof.

### (Polyhydric Phenol)

The polyhydric phenols mentioned above, include resorsin, alkylresorsin, pyrogallol, catechol, alkyl catechol, hydroquinone, alkyl hydroquinone, phloroglucinol, bisphenol, dihydroxynaphthalene or the like. Each polyhydric phenol can be used singly, or as a mixture thereof. Resorsin and alkylresorsin are more suitable than other polyhydric phenols. Alkylresorsin, in particular is the most suitable of polyhydric phenols because alkylresorsin can react with aldehydes more rapidly than resorsin.

The alkylresorsins include 5-methyl resorsin, 5-ethyl resorsin, 5-propyl resorsin, 5-n-butyl resorsin, 4,5-dimethyl resorsin, 2,5-dimethyl resorsin, 4,5-diethyl resorsin, 2,5-diethyl resorsin, 4,5-dipropyl resorsin, 2,5-dipropyl resorsin, 4-methyl-5-ethyl resorsin, 2-methyl-5-ethyl resorsin, 2-methyl-5-propyl resorsin, 2,4,5-trimethyl resorsin, 2,4,5-triethyl resorsin, or the like.

A polyhydric phenol mixture produced by the dry distillation of oil shale, which is produced in Estonia, is inexpensive, includes 5-methyl resorcin, along with many other kinds of alkylresorcin which is highly reactive, so that said polyhydric phenol mixture is an especially desirable raw polyphenol material in the present invention

### [Formaldehyde Donor]

In the present invention, said phenolic compound and aldehyde and/or aldehyde donor (aldehydes) are condensed together. Said aldehyde donor refers to a compound or a mixture which emits aldehyde when said compound or said mixture decomposes. Said aldehyde donor is such as paraformaldehydro, trioxane, hexamethylenetetramine, tetraoxymethylene, or the like.

In the present invention, a formaldehyde and formaldehyde donor are denominated together as a formaldehyde group compound.

### [Production of Phenol Group Resin]

Said phenol group resin has two types, one is a resol type, which is produced by the reaction of said phenol group compound to an excess amount of said formaldehyde group compound using an alkali as a catalyst, and the other novolak type is produced by the reaction of an excess amount of said phenol group compound to said formaldehyde group compound using an acid as a catalyst. Said resol type phenol group resin consists of various phenol alcohols produced by the addition of formaldehyde to phenol and is commonly provided as a water solution, and said novolak phenol group resin consists of various dihydroxydiphenylmethane group derivatives, wherein phenol group compounds are further condensed with phenol alcohols, said novolak type phenol group resin being commonly provided as a powder.

In the use of said phenol group resin in the present invention, said phenol group compound is first condensed with a formaldehyde group compound to produce a precondensate, after which the resulting precondensate is applied to said fiber sheet, which is followed by resinification with a curing agent, and/or heating.

To produce said condensate, monohydric phenol may be condensed with a formaldehyde group compound to produce a homoprecondensate, or a mixture of monohydric phenol and polyhydric phenol may be condensed with a formaldehyde group compound to produce a coprecondensate of monohydric phenol and polyhydric phenol. To produce said coprecondensate, either monohydric phenol or polyhydric phenol may be previously condensed with said formaldehyde group compound to produce a precondensate, or both monohydric phenol and polyhydric phenol may be condensed together.

In the present invention, the desirable phenolic resin is phenol-alkylresorcin cocondensation polymer. Said phenol-alkylresorcin cocondensation polymer provides a water solution of said cocondensation polymer (pre-cocondensation polymer) having good stability, and being advantageous in that it can be stored for a longer time at room temperature, compared with a condensate consisting of only a phenol (precondensation polymer). Further, in a case where said sheet material is impregnated or coated with said water solution by precuring, said material has good stability and does not lose its moldability after longtime storage. Further, since alkylresorcin is highly reactive to a formaldehyde group compound, and catches free aldehyde to react with it, the content of free aldehyde in the resin can be reduced.

The desirable method for producing said phenol-alkylresorcin cocondensation polymer is first to create a reaction between phenol and a formaldehyde group compound to produce a phenolic precondensation polymer, and then to add alkylresorcin, and if desired, a formaldehyde group compound, to said phenolic precondensation polymer to create a reaction.

In the case of method (a), for the condensation of monohydric phenol and/or polyhydric phenol and a formaldehyde group compound, said formaldehyde group compound (0.2 to 3 moles) is added to said monohydric phenol (Imole), after which said formaldehyde group compound (0.1 to 0.8 mole) is added to the polyhydric phenol (1 mole) as usual. If necessary, additives may be added to the phenol resins (the precondensation polymers). In said method(s), there is a condensation reaction caused by applying heat at 55° C. to 100° C. for 8 to 20 hours. The addition of said formaldehyde group compound may be made at once at the beginning of the reaction, or several separate times throughout the reaction, or said formaldehyde group compound may be dropped in continuously throughout said reaction.

Further, if desired, the phenol resins and/or precondensation polymers thereof may be copolycondensed with amino resin monomers such as urea, thiourea, melamine, thiomelamine, dicyandiamine, guanidine, guanamine, acetoguanamine, benzoguanamine, 2,6-diamino-1,3-diamine, and/or with precondensation polymers of said amino resin monomers.

To produce said phenolic resin, a catalyst or a pH control agent may be mixed in, if needed, before, during or after reaction. Said catalyst or pH control agent is, for example, an organic or inorganic acid such as hydrochloric acid, sulfuric acid, orthophosphoric acid, boric acid, oxalic acid, formic acid, acetic acid, butyric acid, benzenesulfonic acid, phenolsulfonic acid, p-toluenesulfonic acid, naphthalene-α-sulfonic acid, naphthalene-β-sulfonic acid, or the like; an organic acid ester such as oxalic dimethyl ester, or the like; an acid anhydride such as maleic anhydride, phthalic anhydride, or the like; an ammonium salt such as ammonium chloride, ammonium sulfate, ammonium nitrate, ammonium oxalate, ammonium acetate, ammonium phosphate, ammonium thiocyanate, ammonium imide sulfonate, or the like; an organic halide such as monochloroacetic acid or its sodium salt, α, α′-dichlorohydrin, or the like; a hydrochloride of amines such as triethanolamine hydrochloride, aniline hydrochloride, or the like; a urea adduct such as salicylic acid urea adduct, stearic acid urea adduct, heptanoic acid urea adduct, or the like; an acid substance such as N-trimethyl taurine, zinc chloride, ferric chloride, or the like; ammonia, amines, an hydroxide of an alkaline metal or alkaline earth metal such as sodium hydroxide, potassium hydroxide, barium hydroxide, calcium hydroxide, or the like; an oxide of an alkalineearth metal such as lime, or the like; an alkaline substance such as an alkalinemetal salt of weak acid such as sodium carbonate, sodium sulfite, sodium acetate, sodium phosphate or the like.

Further, curing agents such as a formaldehyde group compound or an alkylol triazone derivative, or the like, may be added to said phenolic precondensation polymer (including precocondensation polymer).

An alkylol triazone derivative is produced by the reaction between the urea group compound, amine group compound, and formaldehyde group compound. Said urea group compound used in the production of said alkylol triazoned derivative may be such as urea, thiourea, an alkylurea such as methylurea; an alkylthiourea such as methylthiourea; phenylurea, naphthylurea, halogenated phenylurea, nitrated alkylurea, or the like, or a mixture of two or more kinds of said urea group compounds. A particularly, desirable urea group compound may be urea or thiourea. As amine group compounds, an aliphatic amine such as methyl amine, ethylamine, propylamine, isopropylamine, butylamine, amylamine or the like, benzylamine, furfuryl amine, ethanol amine, ethylmediamine, hexamethylene diamine hexamethylene tetramine, or the like, as well as ammonia are illustrated, and said amine group compound is used singly or two or more amine group compounds may be used together.

The formaldehyde group compound(s) used for the production of said alkylol triazone derivative is (are) the same as the formaldehyde group compound used for the production of said phenolic resin precondensation polymer.

To synthesize said alkylol triazone derivatives, commonly 0.1 to 1.2 moles of said amine group compound(s) and/or ammonia, and 1.5 to 4.0 moles of said formaldehyde group compound are reacted with 1 mole of said urea group compound.

In said reaction, the order in which said compounds are added is arbitrary, but preferably, the required amount of formaldehyde group compound is first put in a reactor, after which the required amount of amine group compound(s) and/or ammonia is (are) gradually added to said formaldehyde group compound, the temperature being kept at below 60° C., after which the required amount of said urea group compound(s) is (are) added to the resulting mixture at 80 to 90° C., for 2 to 3 hours, being agitated so as to react together. Usually, 37% by mass of formalin is used as said formaldehyde group compound, but some of said formalin may be replaced with paraformaldehyde to increase the concentration of the reaction product.

Further, in a case where hexamethylene tetramine is used, the solid content of the reaction product obtained is much higher. The reaction between said urea group compound, said amine group compound and/or ammonia, and said formaldehyde group compound is commonly performed in a water solution, but said water may be partially or wholly replaced by one or more kinds of alcohol such as methanol, ethanol, isopropanol, n-butanol, ethylene glycol, diethlene glycol, or the like, and one or more kinds of other water soluble solvent such as ketone group solvent like acetone, methylethyl ketone, or the like can also be used as solvents.

The amount of said curing agent to be added is, in the case of a formaldehyde group compound, in the range of between 10 and 100 parts by mass to 100 parts by mass of said phenolic resin precondensation polymer (precocondensation polymer), and in the case of alkylol triazone, 10 to 500 parts by mass to 100 parts by mass of said phenolic resin precondensation polymerd (precocondensation polymer).

[Sulfomethylation and/or Sulfimethylation of Phenol Group Resin]

To improve the stability of said water soluble phenol group resin, said phenol group resin is preferably sulfomethylated and/or sulfimethylated.

### [Sulfomethylation Agent]

The sulfomethylation agents used to improve the stability of the aqueous solution of phenol resins, include such as water soluble sulfites prepared by the reaction between sulfurous acid, bisulfurous acid, or metabisulfurous acid, and alkaline metals, trimethyl amine, quaternary amine or quaternary ammonium (e.g. benzyltrimethylammonium); and aldehyde additions prepared by the reaction between said water soluble sulfites and aldehydes.

The aldehyde additions are prepared by the addition reaction between aldehydes and water soluble sulfites as mentioned above, wherein the aldehydes include formaldehyde, acetoaldehyde, propionaldehyde, chloral, furfural, glyoxal, n-butylaldehyde, caproaldehyde, allylaldehyde, benzaldehyde, crotonaldehyde, acrolein, phenyl acetoaldehyde, o-tolualdehyde, salicylaldehyde, or the like. For example, hydroxymethane sulfonate, which is one of the aldehyde additions, is prepared by the addition reaction between formaldehyde and sulfite.

### [Sulfimethylation Agent]

The sulfimethylation agents used to improve the stability of the aqueous solution of phenol resins, include alkaline metal sulfoxylates of an aliphatic or aromatic aldehyde such as sodium formaldehyde sulfoxylate (a.k.a. Rongalite), sodium benzaldehyde sulfoxylate, and the like; hydrosulfites (a.k.a. dithionites) of alkaline metal or alkaline earth metal such as sodium hydrosulfite, magnesium hydrosulfite or the like; and a hydroxyalkanesulfinate such as hydroxymethanesulfinate or the like.

In a case where said phenol group resin precondensate is sulfomethylated and/or sulfimethylated, said sulfomethylation agent and/or sulfimethylation agent is(are) added to said precondensate at any stage to sulfomethylate and/or sulfimethylate said phenol group compound and/or said precondensate.

The addition of said sulfomethylation agent and/or sulfimethylation agent may be carried out at any stage, before, during or after the condensation reaction.

The total amount of said sulfomethylation agent and/or sulfimethylation agent to be added is in the range of between 0.001 and 1.5 moles per 1 mole of said phenol group compound. In a case where the total amount of said sulfomethylation agent and/or sulfimethylation agent to be added is less than 0.001 mole per 1 mole of said phenol group compound, the resulting phenol group resin has an insufficient hydrophilic property, while in a case where the total amount of said sulfomethylation agent and/or sulfimethylation agent to be added is beyond 1.5 mols per 1 mole of said phenol group compound, the resulting phenol group resin has insufficient water resistance.

To maintain good performance, such as the curing capability of said produced precondensate, and the properties of the resin after curing and the like, the total amount of said sulfomethylation agent and/or sulfimethylation agent is preferably set to be in the range of between about 0.01 and 0.8 mole for said phenol group compound.

Said sulfomethylation agent and/or sulfimethylation agent added to said precondensate, to the sulfomethylation and/or sulfimethylation of said precondensate, react(s) with the methylol group of said precondensate, and/or the aromatic group of said precondensate, introducing a sulfomethyl group and/or sulfimethyl group to said precondensate.

As described above, an aqueous solution of sulfomethylated and/or sulfimethylated phenol group resin precondensate is stable in a wide range, between acidity (pH1.0), and alkalinity, said precondensate being curable in any range, acidity, neutrality, or alkalinity.

In particular, in a case where said precondensate is cured in an acidic range, the remaining amount of said methylol group decreases, solving the problem of formaldehyde being produced by the decomposition of said cured precondensate.

Into said synthetic resin used in the present invention, further, an inorganic filler, such as calcium carbonate, magnesium carbonate, barium sulfate, calcium sulfate, calcium sulfite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder, or the like; a natural rubber or its derivative; a synthetic rubber such as styrene-butadiene rubber, acrylonitrile-butadiene rubber, chloroprene rubber, ethylene-propylene rubber, isoprene rubber, isoprene-isobutylene rubber, or the like; a water-soluble macromolecule and natural gum such as polyvinyl alcohol, sodium alginate, starch, starch derivative, glue, gelatin, powdered blood, methyl cellulose, carboxy methyl cellulose, hydroxy ethyl cellulose, polyacrylate, polyacrylamide, or the like; an organic filler such as, wood flour, walnut powder, coconut shell flour, wheat flour, rice flour, or the like; a higher fatty acid such as stearic acid, palmitic acid, or the like; a fatty alcohol such as palmityl alcohol, stearyl alcohol, or the like; a fatty acid ester such as butyryl stearate, glycerin mono stearate, or the like; a fatty acid amide; natural wax or composition wax such as carnauba wax, or the like; a mold release agent such as paraffin, paraffin oil, silicone oil, silicone resin, fluorocarbon polymers, polyvinyl alcohol, grease, or the like; an organic blowing agent such as azodicarbonamido, dinitroso pentamethylene tetramine, p,p′-oxibis(benzene sulfonylhydrazide), azobis-2,2′-(2-methylpropionitrile), or the like; an inorganic blowing agent such as sodium bicarbonate, potassium bicarbonate, ammonium bicarbonate or the like; hollow particles such as shirasu balloon, perlite, glass balloon, plastic foaming glass, hollow ceramics, or the like; foaming bodies or particles such as foaming polyethylene, foaming polystyrene, foaming polypropylene, or the like; a pigment; dye; antioxidant; antistatic agent; crystallizer; flameproof agent; water-repellent agent; oil-repellent agent; insecticide agent; preservative; wax; surfactant; lubricant; antioxidant, ultraviolet absorber; plasticizer such as phthalic ester (ex. dibutyl phthalate (DBP), dioctyl phthalate (DOP), dicyclohexyl phthalate) and others (ex. tricresyl phosphate), can be added or mixed.

To impregnate said synthetic resin into said fiber sheet, said fiber sheet is usually dipped into a liquid synthetic resin or synthetic resin solution, or coated using a knife coater, roll coater, flow coater, or the like, or in a case where a synthetic resin powder is used, the synthetic resin is mixed into said fiber mixture to form a sheet.

To adjust the synthetic resin content in said fiber sheet into which said synthetic resin has been impregnated or mixed, said sheet may be squeezed using a squeezing roll or press machine after said synthetic resin has been impregnated or mixed into said fiber sheet. As a result of said squeezing process, the thickness of said fiber sheet may be reduced, and in particular, in a case where said low melting point fibers are contained in said fiber sheet, it is desirable to heat said fiber sheet and melt said low melting point fibers before synthetic resin is impregnated therein, so as to bind the fibers with said melted fibers. Thus, the rigidity and strength of said fiber sheet is improved, so that the workability of said fiber sheet during the process of impregnation with said synthetic resin may be improved, resulting in a remarkable restoration of the thickness of said fiber sheet after being squeezed.

In a case where said synthetic resin is a phenol group resin, and commonly in the case that it is a novolak type phenol group resin, said phenol group resin is mixed in to said fibers as a powdery precondensate, after which said fibers in to which said powdery precondensate has been mixed are sheeted, and in the case of a precondensate aqueous solution, said precondensate solution is impregnated into or coated on to said fiber sheet.

Commonly, said precondensation polymer is prepared as a water solution, but if desired, a water-soluble organic solvent can also be used in the present invention. Said water-soluble organic solvent may be an alcohol, such as methanol, ethanol, isopropanol, n-propanol, n-butanol, isobutanol, sec-butanol, t-butanol, n-amyl alcohol, isoamyl alcohol, n-hexanol, methylamyl alcohol, 2-ethyl butanol, n-heptanol, n-octanol, trimethylnonylalcohol, cyclohexanol, benzyl alcohol, furfuryl alcohol, tetrahydro furfuryl alcohol, abiethyl alcohol, diacetone alcohol, or the like; a ketone such as acetone, methyl acetone, methyl ethyl ketone, methyl n-propyl ketone, methyl n-butyl ketone, methyl isobutyl ketone, diethyl ketone, di-n-propyl ketone, diisobutyl ketone, acetonyl acetone, methyl oxido, cyclohexanone, methyl cyclohexanone, acetophenon, camphor, or the like; a glycol such as ethylene glycol, diethylene glycol, triethylene glycol, propylene glycol, trimethylene glycol, polyethylene glycol, or the like; a glycol ether such as ethylene glycol mono-methyl ether, ethylene glycol mono-ethyl ether, ethylene glycol isopropyl ether, diethylene glycol mono-methyl ether, triethylene glycol mono-methyl ether, or the like; an ester of the above mentioned glycols such as ethylene glycol diacetate, diethylene glycol mono-ethyl ether acetate, or the like, and their derivatives; an ether such as 1,4-dioxane, and the like; a diethyl cellosolve, diethyl carbitol, ethyl lactate, isopropyl lactate, diglycol diacetate, dimethyl formamide, or the like.

After said synthetic resin is impregnated or mixed in said fiber sheet, said fiber sheet in which said synthetic resin has been impregnated or mixed is preferably heated to be dried. In a case where said synthetic resin is thermosetting resin, if said thermosetting resin is put in B stage, the resulting fiber sheet can be stored for a long time, and moreover can be molded in a short time at a low temperature.

### [Flame Retardant]

A flame retardant is preferably mixed into said fiber sheet of the present invention, said flame retardant being such as flame retardant containing phosphorus, flame retardant containing nitrogen, flame retardant containing sulfur, flame retardant containing boron, flame retardant containing bromine, guanidine group flame retardant, phosphate group flame retardant, phosphoric ester flame retardant, amine resin group flame retardant or the like.

A powdery flame retardant, which is insoluble or difficult to dissolve in water, is especially advantageously used in the present invention.

Said powdery flame retardant, which is insoluble or difficult to dissolve in water, imparts flame retardancy having excellent water resistance and durability to said fiber sheet. In particular, since said fiber sheet of the present invention has a thin structure, said powdery solid flame retardant can be smoothly impregnated into the inside of said fiber sheet, so said fiber sheet gains high flame retardancy to non-flamability.

A deisirable flame retardant is capsulated polyammonium phosphate covered with melamine or urea or the like, though price-wise the most desirable flame retardant is polyammonium phosphate, which has an average degree of polymerization in the range of between 10 and 40. Said polyammonium phosphate having said average degree of polymerization is difficult to dissolve, or insoluble in water, and decomposes at a high temperature, to produce a gas having flame retardancy, but said gas having flame retardancy has a low toxicity for human and animals.

Herein said average degree of polymerization is calculated using the following formula.

$$n = \frac{2 \times {P}_{mol}}{{N}_{mol} - {P}_{mol}} \qquad [ Formula 1 ]$$

Wherein Pₘₒₗ shows the mole number of phosphorus contained in said polyammonium phosphate, N moi shows the mole number of nitrogen, and Pmo and Nₘₒₗ are calculated respectively using the following formulae.

$$\begin{matrix}{P}_{mol} = \frac{P content ( \% by mass ) / 100}{Atomic weight of P ( 30.97 )} & [ Formula 2 ] \\ {N}_{mol} = \frac{N content ( \% by mass ) / 100}{Atomic weight of N ( 14.01 )} & [ Formula 3 ]\end{matrix}$$

The analysis of the P content is carried out using, for example, an IPC emission spectrochemical analysis, with an analysis of the N content being carried out using, for example, a CHN measurement method.

In a case where the polyammonium phosphate has an average degree of polymerization greater than 10, said polyammonium phosphate is almost insoluble in water, while in a case where said polyammonium phosphate has an average degree of polymerization beyond 40, when said polyammonium phosphate is dispersed in water or an aqueous solvent, the viscosity of the resulting dispersion increases remarkably, so that in a case where said dispersion is coated onto or impregnated into said fiber sheet, said dispersion is difficult to be uniformly coated onto or impregnated into said fiber sheet, and as a result, it is not guaranteed to provide a fiber sheet having excellent flame retardancy.

In the present invention, as said powdery solid fire retardant, an expandable graphite may be used with said polyammonium phosphate.

The expandable graphite used in the present invention is produced by soaking a natural graphite in an inorganic acid such as concentrated sulfuric acid, nitric acid, selenic acid or the like, and then treating it with an oxidizing agent such as perchloric acid, perchlorate, permanguate, bichromate, hydrogen peroxide or the like, said expandable graphite having an expansion start temperature in the range of between about 250 and 300° C. The expansion volume of said expandable graphite is in the range of between about 30 and 300 ml/g, its particle size is in the range of between about 300 and 30 mesh.

Said powdery solid flame-retardant such as said polyammonium phosphate, expandable graphite, or the like is(are) commonly mixed in with said fiber mixture before a sheet or mat is formed using said fibers, or in a case where the synthetic resin solution or emulsion is impregnated into or coated onto said sheet or mat, or in a case where the synthetic resin is mixed into said fibers, said powdery solid fire retardant may be mixed into said synthetic resin solution or emulsion. Any mixing ratio can be applied, but commonly 0.5 to 100% by mass of said polyammonium phosphate, or in a case of said expandable graphite, 0.5 to 50% by mass of said expandable graphite is mixed in with said fiber mixture.

In a case where said synthetic resin is a water solution, a water soluble resin is preferably dissolved in said water solution. Said water soluble resin may include such as polysodium acrylate, partial saponified polyacrylate, polyvinylalcohol, carboxy methyl cellulose, methyl cellulose, ethyl cellulose, hydroxylethyl cellulose, or the like. Further, an alkali soluble resin such as a copolymer of acrylic acid ester and/or methacrylic acid ester, and an acrylic acid and/or methacrylic acid, or a slightly cross-linked copolymer of the above mentioned copolymer, and the like may be used as said water soluble resin of the present invention. Said copolymer or said slightly cross-linked copolymer is commonly provided as an emulsion.

In a case where said water soluble resin is dissolved in said synthetic resin water solution, said water solution may be thickened to improve the stability of dispersion, making it difficult for said polyammonium phosphate and said expandable graphite sediment, preparing a uniform dispersion.

Further; the adhesiveness of said polyammonium phosphate and said expandable graphite to said fibers may be improved by said water soluble resin, preventing the release of said polyammonium phosphate and said expandable graphite from said fiber sheet.

Said water soluble resin may be commonly added to said water solution in an amount in the range of between 0.1 and 20% by mass as a solid.

Further, to add said powdery solid flame retardant, such as said polyammonium phosphate, or expandable graphite to said fiber sheet, a dispersion of said polyammonium phosphate, or expandable graphite may be coated onto or impregnated in to said fiber sheet, after said synthetic resin is impregnated in to said fiber sheet, wherein said dispersion is prepared by dispersing said polyammonium phosphate, expandable graphite into said synthetic resin aqueous solution of water soluble resin such as polysodium acrylate, partially saponified polyacrylate, polyvinylalchohol, carboxy methiy cellulose, methyl cellulose, hydroxymethyl cellulose, hydroxylethyl cellulose or the like, or a synthetic resin emulsion such as an emulsion of alkali soluble resin such as a copolymer of acrylate and/or methacrylate, and acrylic acid and/or methacrylic acid, or a slightly cross linked copolymer as described above, or the like.

To disperse said powdery solid flame retardant of said polyammonium phosphate, expandable graphite, or the like into said synthetic resin emulsion or aqueous solution, a homomixer, a supersonic wave type emulsifying machine or the like is preferably used.

In a case where a supersonic type emulsifying machine is used, said polyammonium, or expandable graphite, is uniformly dispersed in said aqueous solution or synthetic resin emulsion. In particular, said expandable graphite is powdered by the supersonic effect, and in a case where said synthetic resin emulsion or aqueous solution into which said powdered expandable graphite has been uniformly dispersed is impregnated in to a fiber sheet, said expandable graphite easily penetrate to the inside of said fiber sheet, improving the flame retardancy of said fiber sheet.

### [Molding of the Fiber Sheet]

Said fiber sheet of the present invention is molded into a panel shape or prescribed shape, generally by hot-press molding, and in a case where a thermosetting resin is impregnated into said fiber sheet, said hot-press molding is carried out at a temperature over the hardening start temperature of said thermosetting resin, and in a case where said expandable graphite is used in said fiber sheet, said hot press-molding is carried out at a temperature below expansion start temperature of said expandable graphite. Said fiber sheet of the present invention may be hot-pressed into a prescribed shape after said fiber sheet has been hot-pressed into a flat panel, and further, in a case where fibers having a low melting point, or a thermoplastic resin is contained in said fiber sheet, said fiber sheet may be heated so as to soften said low melting point fibers or said thermoplastic resin, after which said fiber sheet may be cold-pressed into a prescribed shape As described above, however, since said fiber sheet of the present invention contains other fiber, especially low melting point fiber, in an amount of less than 45% by mass, even when said hot-pressing is applied at a temperature of over the melting point of said low melting point fiber, said fiber sheet has good releasability. A plural number of said sheets are laminated together.

Said sheet of the present invention is useful as a base panel for the interior or exterior of a car, such as head lining, dash silencer, hood silencer, under engine cover silencer, cylinder head cover silencer, outer dash silencer, floor mat, dash board, door trim or reinforcement that is laminated on to said base panel, or a sound insulating material, heat insulating material, or building material.

Nonwoven fabric(s) may be laminated onto one side or both sides of said fiber sheet of the present invention. To bond said fiber sheet and said nonwoven fabric(s), a hot melt adhesive sheet or a hot melt adhesive powder is used, and further in a case where a synthetic resin has been coated onto said fiber sheet, said nonwoven fabric(s) may be bonded to said fiber sheet by said synthetic resin.

Said hot melt adhesive sheet or hot melt adhesive powder is made of a synthetic resin having a low melting point, for example, a polyolefine group resin (including modified polyolefine resin) such as polyethylene, polypropylene, ethylene-vinyl acetate copolymer, ethylene-ethylacrylate copolymer, or the like; polyurethane, polyester, polyester copolymer, polyamide, polyamide copolymer or a mixture of two or more kinds of said synthetic resin having a low melting point.

In a case where said hot melt adhesive sheet is used as an adhesive, for example said hot melt adhesive sheet is laminated onto said fiber sheet by extruding said hot melt adhesive sheet from a T-die, after which said nonwoven fabric is laminated onto said fiber sheet, then hot press molded.

For the purpose of ensuring air permeability, said hot melt sheet is preferably porous. To make said hot-melt sheet porous, a lot of fine holes are first made on said hot-melt sheet, or said hot-melt sheet is laminated on to said flame retardant sheet, and then needle punched, or the like, or a heated and softened hot-melt sheet which has been extruded from the T die is laminated on to said fiber sheet, after which the layered material is pressed. The resulting film may become porous, having a lot of fine holes. Said holes in said thermoplastic resin film may be formed by the shag on the surface of said fiber sheet. In this method, no process is necessary to form holes in said film, and fine holes may give the product an improved sound absorption property. In a case where said hot-melt adhesive powder is used for adhesion, the resulting molded article's air permeability is ensured.

The ventilation resistance of said molded laminated sheet manufactured by the molding of said laminated sheet is preferably in the range of between 0.1 and 100 kPa s/m. Said molded laminated sheet has an excellent sound absorption property.

EXAMPLES of the present invention are described below. However, the scope of the present invention should not be limited by only said EXAMPLES.

### Examples 1 to 3 and Comparisons 1 to 3

Fiber mixtures having compositions shown in table 1 were used

TABLE 1

| | Example | | | Comparison | | |
|---|---|---|---|---|---|---|
| Fiber | 1 | 2 | 3 | 1 | 2 | 3 |
| Kenaf | 95 | 80 | 55 | 98 | 50 | — |
| Ordinary PET fiber | — | 10 | 35 | — | 40 | 90 |
| PET fiber having a | 5 | 10 | 10 | 2 | 10 | 10 |
| low melting point | | | | | | |

Kenaf fiber: fineness 13 to 15 dtex, length 70 mm
Ordinary PET fiber: fineness 6.6 dtex, length 50 mm, melting point 250° C.
Composite PET fiber having a low melting point (L-PET fiber): fineness 4.4 dtex, length 60 mm, core component: said ordinary PET, shell component: PET having a low melting point, melting point 130° C.
Said kenaf fiber and polyester (PET) fiber were mixed in a ratio (% by mass) shown by Table 1 EXAMPLES 1 to 3, and COMPARISONS 1 to 3, and a websheet having a thickness of 30 to 35 mm, and a unit weight of 500 g/m² was formed by defibrating each fiber mixture with a defibrater, and then the resulting websheet was heated in a hot-air oven at 135° C. for 40 seconds to melt said PET(L-PET) fiber having a low melting point, and to bind fibers together, and a fiber sheet, each fiber sheet having a thickness of 30 mm, and an apparent density of 16.6 kg/m³, was prepared.

Following this, each fiber sheet was then dipped in a resin mixture solution comprising 40 parts by mass of a phenol-folmaldehyde precondensation polymer (water solution: solid content 50% by mass), 2 parts by mass of carbon black dispersion (solid content 30% by mass), 5 parts by mass of a flame retardant containing nitrogen and phosphorus (water solution: solid content 30% by mass), and 53 part by mass of water, the amount of said resin mixture impregnated into each fiber sheet being adjusted to be 50% by mass for said fiber sheet, by roll squeezing, after which each fiber sheet into which said resin mixture was impregnated, was then dried at 120° C. for ten minutes to prepare a resin impregnated fiber sheet having a thickness of 25 mm. The resulting resin impregnated fiber sheet was then molded by hot pressing at 200° C. for 60 seconds, to prepare a molded fiber sheet into a prescribed shape. The situation of each stage in the process of preparing each molded fiber sheet is shown in Table 2.

TABLE 2

| | Example | | | Comparison | | |
|---|---|---|---|---|---|---|
| Stage | 1 | 2 | 3 | 1 | 2 | 3 |
| Preparing fiber | ⊚ | ⊚ | ⊚ | Δ | ⊚ | ⊚ |
| sheet | | | | | | |
| Roll squeezing | ⊚ | ⊚ | ⊚ | X | ⊚ | ⊚ |
| Demolding | ⊚ | ⊚ | ⊚ | — | X | XX |
| after | | | | | | |
| hotpressing | | | | | | |

### Stage: Preparing Fiber Sheet

The appearance and handling easiness of each fiber sheet was judged.
⊚: Good appearance and no form crumbling by handling.
Δ: Good appearance but a little form crumbling by handling.

### Stage: ROLL Squeezing.

Each fiber sheet was dipped into said resin mixture solution and then roll squeezed, after which the situation of each fiber sheet was judged.
⊚: No loosening of fiber sheet, and less contraction of its thickness.
X: Delamination of fiber sheet when the roll was pressed thereon, said fiber partially sticking onto the roll.
   Stage: Demolding after Hot Pressing

When each molded fiber sheet was demolded, whether said molded sheet kept its molded shape without deformation or not was judged.
⊚: The rigidity of the molded fiber sheet was good without softening and deforming when demolding, and demolding was easy.
X: The molded fiber sheet was soft and deformed with demolding, its handling deteriorated.
XX: The molded fiber sheet softened remarkably and deformed, and moreover also contracted, so that molding of said fiber sheet into a prescribed shape cannot be carried out.

### Examples 4 to 6 and Comparisons 4 and 5

In EXAMPLES 1 to 3 and COMPARISONS 2 and 3 (excepting COMPARISON 1), the amount of said resin mixture solution to be impregnated in to each fiber sheet was respectively adjusted to 5, 10, 100, 200, and 250% by mass for the fiber sheet and other manners were the same as in EXAMPLES 1 to 3 and COMPARISONS 2 and 3, to prepare the molded fiber sheet into a prescribed shape.

Situations in each stage of the process of preparing each molded fiber sheet is shown in Table 3.

TABLE 3

| Amount of resin | Fiber sheet | |
|---|---|---|
| mixtures solution to | Example | Comparison |

| Stage | | be inpregnated (%) | 1 | 2 | 3 | 2 | 3 |
|---|---|---|---|---|---|---|---|
| Roll squeezing | Comparison 4 | 5 | ⊚ | ⊚ | ⊚ | ⊚ | ⊚ |
| | Example 4 | 10 | ⊚ | ⊚ | ⊚ | ⊚ | ⊚ |
| | Example 5 | 100 | ⊚ | ⊚ | ⊚ | ⊚ | ⊚ |
| | Example 6 | 200 | ⊚ | ⊚ | ⊚ | ⊚ | ⊚ |
| | Comparison 5 | 250 | ⊚ | ⊚ | ⊚ | ⊚ | ⊚ |
| Demolding after | Comparison 4 | 5 | X | X | X | X | XX |
| hotpressing | Example 4 | 10 | ⊚ | ⊚ | ⊚ | ⊚ | ⊚ |
| | Example 5 | 100 | ⊚ | ⊚ | ⊚ | ⊚ | ⊚ |
| | Example 6 | 200 | ⊚ | ⊚ | ⊚ | ⊚ | ⊚ |
| | Comparison 5 | 250 | ⊚ | ⊚ | ⊚ | ⊚ | ⊚ |
| Appearance of | Comparison 4 | 5 | X | X | X | X | XXX |
| molded fiber | Example 4 | 10 | ◯ | ◯ | ◯ | X | XXX |
| sheet | Example 5 | 100 | ⊚ | ⊚ | ⊚ | X | X |
| | Example 6 | 200 | ⊚ | ⊚ | ⊚ | X | X |
| | Comparison 5 | 250 | XX | XX | XX | XX | XX |

Judgments for stage (roll squeezing) and stage (demolding after hot pressing) are the same as Table 2.

The appearance of the molded fiber sheet.

The appearance of each molded fiber sheet was checked as to whether said molded fiber sheet had flexibility and rigidity but no plastic-like hardness keeping its fibrous nature or not.
⊚: having proper flexibility and rigidity without a plastic like hardness, and having a good appearance.

◯: having slightly poor rigidity, but keeping its molded shape, and having on the whole good appearance.
X: having poor rigidity and warping and breaking with handling
XX: having an excess of hardness, being plastic like without a fibrous nature, and having inferior appearance.
XXX: Deformation of the molded fiber sheet and remarkable contraction, so regular dimension is not secured.

### [Discussion Referring to the Results in Tables 2 and 3 Relating to Examples 1 to 6 and Comparison 1 to 5]

In a case where a fiber sheet is prepared by using a fiber mixture of rigid vegetable fiber and synthetic resin fiber wherein fiber having a low melting point is used as a binder, it is clear that more than 5% by mass of said fiber having a low melting point should be added to said fiber mixture. In a case where the added amount of said fiber having a low melting point is short, it is proved that even if the fiber sheet can be prepared, the delamination of the fiber sheet is caused in the stage wherein the resin mixture water solution is impregnated into said fiber sheet.

Further, in a case where said fiber sheet consists of only said synthetic fiber excepting rigid vegetable fiber or in a case where the amount of said rigid vegetable fiber in said fiber sheet is not enough, it is recognized that when the molded fiber sheet is demolded after hot-pressing, said molded fiber sheet may deform or cause molding shrinkage, as a result, said molded fiber sheet has the wrong shape.

To compensate for said faults, it is considered that the amount of said thermosetting resin to be added to said fiber sheet be increased, but in this case, said fiber sheet has a plastic-like appearance, and no fibrous feeling. The advantages of rigid vegetable fiber in said fiber sheet are as follows. Since said rigid vegetable fiber has no definite melting point different from synthetic resin fiber such as polyester, polyamide and polypropylene, said rigid vegetable fiber does not soften when heated at about 200° C. in a hot press stage, so that the resulting molded fiber sheet keeps its molded shape in the demolding stage after hot pressing. Accordingly said fiber sheet can hold its molded shape even when the amount of the thermosetting resin added is small, and also has a good rigidity and form stability, further minor molding shrinkage, and an excellent appearance.

### Examples 7 to 9 and Comparisons 6 and 7

A fiber mixture was prepared by mixing with air layering 60% by mass of kenaf fiber (fineness: 13 to 15 dtex, fiber length: 70 mm), 10% by mass of polyester fiber (fineness: 6.6 dtex, fiber length: 45 mm) and 30% by mass of core shell type composite polyester fiber having a low melting point (fineness: 4.4 dtex, fiber length: 50 mm, melting point of shell part: 150° C.), the resulting mixture being formed into a web sheet by a defibrater. The resulting web sheet was then heated at 155° C. in a hot air oven for 40 seconds to melt said polyester fiber having a low melting point, and to bind said fibers together, and fiber sheets having apparent densities of 2, 5, 30, 50, and 100 kg/m³ were each prepared, each fiber sheet having a thickness of 30 mm. A resin mixture solution consisting of 40 parts by mass of sulfomethylated phenol-alkylresorcin-folmaldehyde precondensation polymer (water solution: solid content 50% by mass), 2 parts by mass of carbon black dispersion (solid content 30% by mass), 20 parts by mass of polyammonium phosphate having an average polymerization degree of n=20 (particle size 25 μm) as a flame retardant, and 38 parts by mass of water was prepared, and each fiber sheet was dipped into said resin mixture solution, adjusting the amount of said resin mixture solution impregnated therein to be 50% by mass of said fiber sheet by roll squeezing, after which each fiber sheet was dried at 140° C. in a drier for 10 minutes to prepare resin impregnated fiber sheets having a thickness of 25 mm. Each resin impregnated fiber sheet prepared as described above was molded by hot pressing at 200° C. for 70 seconds, to prepare a molded fiber sheet having a thickness of 10 mm.

Test results of each molded fiber sheet were shown in Table 4.

TABLE 4

| | |
|---|---|
| Example | Comparison |

| | 7 | 8 | 9 | 6 | 7 |
|---|---|---|---|---|---|
| Density (kg/m³) | 5 | 30 | 50 | 2 | 100 |
| Situation of resin | ⊚ | ⊚ | ⊚ | ⊚ | X |
| impregnated molded | | | | | |
| fiber sheet | | | | | |
| Flame retardancy | ⊚ | ⊚ | ⊚ | ⊚ | X |
| test | | | | | |
| Rigidity | ⊚ | ⊚ | ⊚ | X | Δ |

### Situation of Resin Impregnated Fiber Sheet

Situation of each resin impregnated fiber sheet having a thickness of 25 mm prepared as described above was checked.
⊚: The resin and the flame retardant were uniformly impregnated into the middle of the fiber sheet.
X: The flame retardant was not impregnated into the middle of the fiber sheet and mostly remained on the surface of the fiber sheet.

### Flame Retardancy Test

Flame retardancy was determined by UL94 standard
⊚: having a good retardancy and V-0 of UL94 standard
X: burning because of the flame retardant being not uniformly impregnated

### Rigidity

Check by touching the molded fiber sheet with hand.
⊚: proper rigidity and good fibrous feeling, with no deformation by handling
Δ: high rigidity but plastic like feeling and no fibrous feeling.
x: poor rigidity and deformation by handling.

Referring to Table 4 relating to EXAMPLES 7 to 9 and COMPARISON 6 and 7, in a case where the apparent density of the fiber sheet is below 4 kg/m3, the resulting molded fiber sheet has a poor rigidity and is difficult to handle. On the other hand, in a case where the apparent density of the fiber sheet is beyond 50 kg/m3, powdery flame retardant can not be impregnated into the inside of the fiber sheet, so that the resulting molded fiber sheet has a poor flame retardancy, and further, a plastic like appearance.

### Comparisons 8 to 10

The same process was applied as in examples 7 to 9 with the exception that kenaf fibers having a fineness of 6 to 7 dtex were used, and molded fiber sheets each having a thickness of 10 mm, were prepared using fiber sheets each having apparent densities of 5, 30 and 50 kg/m³.

The test results of the resulting molded fiber sheets were shown in Table 5.

TABLE 5

| | Comparison | | |
|---|---|---|---|
| | 8 | 9 | 10 |
| Density (kg/m³) | 5 | 30 | 50 |
| Situation of resin | X | X | X |
| impregnated molded | | | |
| fiber sheet | | | |
| Flame retardancy | X | X | X |
| test | | | |
| Rigidity | ⊚ | ⊚ | ⊚ |

### Examples 10 and 11 and Comparisons 11 and 12

TABLE 6

| | |
|---|---|
| Example | Comparison |

| Fiber | 10 | 11 | 11 | 12 |
|---|---|---|---|---|
| Kenaf fiber (7 to 8 dtex) | 35 | 60 | 45 | 52 |
| Kenaf fiber (12 to 15 dtex) | 25 | — | 15 | 8 |
| PET fiber (6.6 dtex) | 30 | — | 30 | 20 |
| PET fiber (15 dtex) | — | 30 | — | 10 |
| L-PET fiber (4.4 dtex) | 10 | 10 | 10 | 10 |

Fiber mixtures having the composition ratio (parts by mass) shown in Table 6 were prepared, wherein the length of each fiber was 60 mm, and the L-PET fiber was a core-shell type composite fiber, its shell component having a melting point of 130° C.

A web sheet having a thickness of 30 to 35 mm and a unit weight of 500 g/m² was formed by a defibrater using each fiber mixture, and each resulting web sheet was then heated in a hot air oven at 135° C. for 40 seconds to melt the PET fiber having a low melting point (L-PET fiber), and to bind said fibers together and thus a fiber sheet having a thickness of 40 mm, and apparent density of 12.5 kg/m³ was prepared from each web sheet.

A resin mixture solution consisting of 40 parts by mass of a sulfomethylated phenol-alkyl resorcin formaldehyde precondensation polymer (water solution: solid content 50% by mass), 2 parts by mass of a carbon black dispersion (solid content: 30 parts by mass), 20 parts by mass of polyammonium phosphate covered with a melamine resin (particle size 50 μm) as a flame retardant, and 38 parts by mass of water was prepared. Said resin mixture solution was impregnated into each fiber sheet described above, and the amount to be impregnated was adjusted to be 40% by mass for the fiber sheet by roll squeezing, after which each fiber sheet was then dried at 120° C. for 10 minutes in a drier, to prepare a resin impregnated fiber sheets, each fiber sheet having a thickness of 30 mm.

The resulting resin impregnated fiber sheets were each molded by hot-pressing at 200° C. for 70 seconds to prepare molded fiber sheets, each molded fiber sheet having a thickness of 10 mm. The test results of the resulting molded fiber sheets are shown in Table 7.

TABLE 7

| | |
|---|---|
| Example | Comparison |

| | 10 | 11 | 11 | 12 |
|---|---|---|---|---|
| Situation of resin | ⊚ | ⊚ | X | X |
| impregnated molded | | | | |
| fiber sheet | | | | |
| Flame retardancy | ⊚ | ⊚ | X | X |
| test | | | | |
| Rigidity | ⊚ | ⊚ | ⊚ | ⊚ |

Referring to Table 5 relating to COMPARISONS 8 to 10 and Table 7 relating to EXAMPLES 10 and 11, and COMPARISON 11 and 12, it is recognized that in a case where said fiber mixture does not contain fiber having a fineness of more than 10 dtex in an amount of more than 20% by mass, even in the case of said fiber sheet having preferable apparent density, the powdery flame retardant cannot be uniformly impregnated into the inside of the fiber sheet, resulting in the serious damage being done to the flame retardancy of the resin impregnated molded fiber sheet.

The reason for said problem with the flame retardancy may be as follows. In the case that a the fiber mixture in which a lot of fibers having a small fineness are contained is formed into said fiber sheet, the resulting fiber sheet will have small spaces between its fibers, and the flame retardant powders will be filtered by the surface of said fiber sheet, fixing said flame retardant powders only to the surface of said fiber sheet, so that the resulting molded fiber sheet will have a poor fire retardancy.

### Example 12

A fiber mixture was prepared, said fiber mixture consisting of 40% by mass of kenaf fiber (fineness: 15 to 17 dtex, fiber length: 60 mm), 10% by mass of poly lactic acid fiber (fineness: 6.6 dtex, fiber length: 55 mm), 30% by mass of bamboo fiber (fineness: 12 to 14 dtex, fiber length: 60 mm), and 20% by mass of core-shell type composite polyester fiber having a low melting point (fineness 4.4 dtex, fiber length: 51 mm, melting point of shell component: 110° C.). A web sheet was prepared by a defibrater using said fiber mixture, said web sheet having a thickness of 40 mm, and a unit weight of 600 g/m². The resulting web sheet was then heated in a hot air oven with siction at 115° C. for 30 seconds to melt said core-shell type composite polyester fiber having a low melting point, and to bind said fibers together, and a fiber sheet having a thickness of 30 mm, and an apparent density of 19.9 kg/m² was prepared. A resin mixture consisting of 60 parts by mass of phenol formaldehyde precondensation polymer (water solution: solid content 50% by mass), 20 parts by mass of polyammonium phosphate having an average polymerization degree of n=35 (particle size 25 μm), 1 part by mass of carbon black water dispersion (30% by mass solid content), 4 parts by mass of a water and oil repellent agent containing fluorine (water solution: solid content 30% by mass), and 15 parts by mass of water was prepared, then said fiber sheet was dipped into said resin mixture to adjust the amount impregnated to be 70% by mass for the fiber sheet by roll squeezing, after which said fiber sheet into which said resin mixture was impregnated was then dried in a drier with suction at 100° C. for 10 minutes to prepare a resin impregnated fiber sheet having a thickness of 25 mm. The resulting resin impregnated fiber sheet was then molded by hot pressing at 200° C. for 60 seconds into a prescribed shape to prepare a molded fiber sheet. The resulting molded sheet has a flame retardancy V-0 by JL94 standard, and excellent water resistance and weather resistance, and is useful for the interior or exterior of a car or building.

### Example 13

A resin mixture was prepared, said resin mixture consisting of 40 parts by mass of phenol-resorcin-formaldehyde pre-condensation polymer (water solution: solid content 60% by mass), 1 part by mass of carbon black water dispersion (solid content 30% by mass) 4 parts by mass of a water and oil repellent agent containing fluorin (water solution: solid content 20% by mass), 7 parts by mass of a flame retardant containing nitrogen and phosphorus (water solution: solid content 40% by mass), and 48 parts by mass of water. Said resin mixture was impregnated into a spun bonded nonwoven fabric made of polyester fiber having an unit weight 50 g/m², and then said spun bonded nonwoven fabric was roll squeezed to adjust the amount impregnated to be 40% by mass for said spun bonded nonwoven fabric, after which it was then dried in a drier at 150° C. for 5 minutes, to prepare a surface material. The resulting surface material was then laminated onto said resin impregnated fiber sheet prepared in Example 12, and the resulting laminated sheet was then molded by hot-pressing at 210° C. for 60 seconds into a prescribed shape.

The resulting molded laminated sheet has a flame retardancy V-0 by UL94 standard, has an excellent water resistance and weather resistance, and is useful for the interior and exterior of a building or a car.

### Example 14

A fiber mixture was prepared by uniformly mixing with air layering, said fiber mixture consisting of 40 parts by mass of kenaf fiber (fineness: 15 to 17 dtex, fiber length: 70 mm), 30 parts by mass of bamboo fiber (fineness: 10 to 12 dtex, fiber length: 65 mm), and 30 parts by mass of a core-shell type polyester fiber having a low melting point (fineness: 4.4 dtex, fiber length: 51 mm melting point of shell component: 150° C.). A web sheet was then prepared by carding said fiber mixture with air, and then lightly needle punching, said web sheet had a thickness of 20 mm and unit weight of 500 g/m². The resulting web sheet was then heated in a hot air oven with suction at 155° C. for 40 seconds, to melt said polyester fiber having a low melting point, and to bind fibers together, and thus a fiber sheet having a thickness of 15 mm, and an apparent density of about 33.3 kg/m³ was prepared. A resin mixture consisting of 60 parts by mass of sulfomethylated phenol-alkyl resorcin-formaldehyde pre-condensation polymer (water solution: solid content 50% by mass), 20 parts by mass of polyammonium phosphate having an average polymerization degree of n=20 (particle diameter: 15 μm), and 20 parts by mass of water was prepared.

The resulting resin mixture was then impregnated into said fiber sheet by roll coating, the coated amount of said resin mixture being adjusted to be 80% by mass for said fiber sheet, then said fiber sheet into which said resin mixture was impregnated was dried in a drier with suction at 140° C. for 10 minutes to prepare a resin impregnated fiber sheet having a thickness of 13 mm.

Said surface material prepared in EXAMPLE 13 was laminated onto one side of said resin impregnated fiber sheet, and the resulting laminated sheet was then molded into a prescribed shape by hot pressing at 210° C. for 60 seconds, to prepare a molded laminated sheet.

The resulting molded laminated sheet was then exposed to the outdoors for six months as a weather resistant test, and as a result, the bending strength of said molded laminated sheet degraded about 5% from its initial bonding strength, but after said weather resistance test, said molded laminated sheet also had a flame retardancy of V-0 by UL94 standard, as well as an excellent water resistance, and weather resistance and is useful for the interior and exterior of a building or a car.

### Example 15

A fiber mixture was prepared by mixing with a defibrater, said fiber mixture consisting of 70% by mass of kenaf fiber (fineness: 13 to 15 dtex, fiber length: 60 mm), 15% by mass of polyester fiber (fineness: 33 dtex, fiber length: 70 mm) and 15% by mass of core-shell type polyester composite fiber having a low melting point (fineness: 4.4 dtex, fiber length: 51 mm, melting point of shell component: 160° C.).

Said fiber mixture was formed into a web sheet, and said web sheet was heated in a hot air oven with suction at 180° C. for 60 seconds, to melt said polyester fiber having a low melting point, and to bind said fibers together, and thus a resin impregnated fiber sheets having a thickness of 32 mm and an apparent density of about 20.0 kg/m³ was prepared. A resin mixture consisting of 50 parts by mass of sulfomethylated phenol-alkyl resorcin-formaldehyde precondensation polymer (water solution: solid content 50% by mass), 20 parts by mass of polyammonium phosphate having an average polymerization degree of n=30 (particle diameter: 15 μm), 1 part by mass of carbon black dispersion (solid content 30% by mass), and 29 parts by mass of water, was prepared. Said fiber sheet was dipped into said resin mixture to adjust the amount impregnated to be 60% by mass for the fiber sheet by roll squeezing, after which said fiber sheet into which said resin mixture was impregnated was then dried in a drier with suction at 130° C. for 10 minutes to prepare a resin impregnated fiber sheet having a thickness of 30 mm. Said surface materials prepared in EXAMPLE 13 were laminated onto both sides of said resin impregnated fiber sheet and then the resulting laminated fiber sheet was molded by hot-pressing at 200° C. for 90 seconds into a prescribed shape, to prepare a molded laminated fiber sheet.

The fire retardancy of the resulting molded laminated fiber sheet is V-0 by UL94 standard, and said molded laminated sheet has an excellent water resistance, weather resistance, and water and oil repellency and is useful as the interior and exterior of a building or a car.

### Comparison 13

A fiber mixture was prepared by uniformly mixing with air layering, said fiber mixture consisting of 40 parts by mass of kenaf fiber (fineness: 15 to 17 dtex, fiber length: 70 mm), 30 parts by mass of bamboo fiber (fineness: 10 to 12 dtex, fiber length: 65 mm) and 30 parts by mass of polypropylene fiber (fineness: 6.6 dtex, fiber length: 60 mm).

A web sheet was prepared from the resulting fiber mixture by air carding and then light needle punching, the resulting web sheet had a thickness of 20 mm and unit weight 500 g/m².

The resulting web sheet was then heated in a hot air oven with suction at 155° C. for 20 seconds to melt said polypropylene fiber, and to bind said fibers together, and thus a fiber sheet having a thickness of 15 mm was prepared. Said surface material prepared in EXAMPLE 13 was laminated onto one side of the resulting fiber sheet, and the resulting laminated fiber sheet was hot pressed at 210° C. for 60 seconds, and then cold pressed into a prescribed shape, to prepare a molded laminated fiber sheet. The resulting molded laminated fiber sheet burned easily and after exposure to the outdoors for six months, the bending strength of said molded laminated fiber sheet lost 70% of its initial bending strength and partial corrosion was also observed.

### INDUSTRIAL UTILITY

The fiber sheet and the molded fiber sheet of the present invention has a good rigidity and sound absorbing property and further, an excellent molded form stability, and so useful for the interior and exterior of a car and the like.

1. A fiber sheet consisting of a fiber mixture including 55 to 95% by mass of rigid vegetable fiber and 5 to 45% by mass of other fiber, wherein said rigid vegetable fiber having a fineness of 10 dtex or above, and/or said other fiber is(are) contained in said fiber sheet in an amount of 20% by mass or above, the apparent density of said fiber sheet being in the range of between 4 and 50 kg/cm², and further powdery polyammonium phosphate, having an average degree of polymerization in the range of between 10 and 40, with its particle diameter 200 μm or below, being mixed into said fiber sheet.

2-3. (canceled)

4. A fiber sheet in accordance with claim 1, wherein the whole of or a part of said other fiber is a fiber having a low melting point of 180° C. or below.

5. A fiber sheet in accordance with claim 4, wherein said fiber having a low melting point is a core-shell type composite fiber, the shell part of which is made of a thermoplastic synthetic resin having a low melting point of between 100 and 180° C.

6. A fiber sheet in accordance with claim 1, wherein the fibers of said fiber sheet are intertwined by needle punching, and/or bound by a synthetic resin binder and/or a melted fiber having a low melting point.

7. A fiber sheet in accordance with claim 1, wherein a synthetic resin is impregnated therein.

8. A fiber sheet in accordance with claim 7, wherein said synthetic resin is a phenolic resin.

9. A fiber sheet in accordance with claim 8, wherein said phenolic resin is sulfomethylated and/or sulfimethylated.

10. A fiber sheet in accordance with claim 1, wherein a powdery solid flame retardant is mixed therein.

11. (canceled)

12. A laminated fiber sheet wherein a non-woven fabric(s) is(are) laminated onto one side or both sides of said fiber sheet in accordance with claim 1.

13. A molded fiber sheet, wherein a fiber sheet in accordance with claim 1, is molded into a desired shape.
